(19) United States
(12) Patent Application Publication
(10) Pub. No.: US 2004/0145098 A1
(43) Pub. Date: Jul. 29, 2004

(54) Energy absorber for fall arrest systems

(76) Inventor: Ken Thaler, Parry Sound (CA)

Correspondence Address: KUSNER & JAFFE, HIGHLAND PLACE SUITE 310, 6151 WILSON MILLS ROAD, HIGHLAND HEIGHTS, OH, 44143, US

(21) Appl. No.: 10/652,102

(22) Filed: Aug. 29, 2003

(30) Foreign Application Priority Data
Jan. 28, 2003 (CA) 2417592

(51) Int. Cl. B60G 11/52

(52) U.S. Cl. 267/33

(57) ABSTRACT

An energy absorber for use in a fall arrest system is disclosed and comprises a housing, a plunger and a compressible cushion. The housing has a tubular body and an end wall. The body defines a longitudinal axis. The end wall is secured to the body and has defined therethrough an aperture. The plunger includes a head disposed within said body and a rod extending from said head, through the aperture in the end wall, to a terminal end. The plunger is disposed at a rest position, whereat the head is relatively distal to the end wall, and is mounted to the housing for longitudinal movement between the rest position and an extended position, whereat the head is relatively proximal to the end wall. The cushion is disposed within the body between the end wall and the plunger head, for compression by the plunger upon said longitudinal movement thereof.

### FIELD OF THE INVENTION

The present invention relates to the field of fall protection systems, and particularly, to energy absorbers for use therein.

### BACKGROUND OF THE INVENTION

It is known to provide fall protection systems for workers on elevated structures.

Such fall protection systems commonly consist of a lifeline, which may be a vertical lifeline anchored to an elevated point of the structure or a horizontal lifeline, which extends between horizontally spaced elevated anchorages. Persons working in the vicinity of the lifeline may don a safety harness or belt, and attach same to the lifeline by means of a lanyard, for protection against injury from falls.

It is well known to include means for absorbing energy in such fall protection systems, so as to ensure that the maximum arrest forces exerted upon persons using such fall protection systems do not exceed physically injurious levels, and also to reduce the force placed on the anchorages therefor to manageable levels.

In some applications, this may be affected simply by providing elasticity in the lifeline and/or lanyard. However, this methodology requires great care in deployment, particularly when the lifeline is lengthy, as is the case when anchorages are horizontally-spaced far apart from one another, since excessive elasticity in a lifeline may, disastrously, allow a user to come into contact with the ground, or other obstructions, prior to deceleration.

As well, excessive elasticity can result in undesirable rebound, increasing the chance of injury.

Accordingly, in modern fall protection systems, it is most common to utilize a substantially inelastic lifeline and to delegate energy absorption functionality to separate energy absorption apparatus which does not exhibit undesirable rebound.

Energy absorption apparatus interposed between a horizontal lifeline and its anchorage are most commonly termed “energy absorbers”, and energy absorption apparatus interposed between a lanyard and a harness are most commonly termed “shock absorbers” but the terms are used somewhat interchangeably in the art, and indeed, many types of energy absorption apparatus are used interchangeably (to wit, in both applications). Accordingly, such apparatus are hereinafter referred to universally as “energy absorbers” for simplicity.

One class of energy absorber of the prior art is exemplified by U.S. Pat. No. 5,598,900 (O'Rourke), issued Feb. 4, 1997. In this energy absorber, a pair of rings are provided, which are secured to one another by a strip of tear-ply webbing material and by a strip of woven webbing material.

In a fall, the tear-ply webbing separates incrementally, with consequent absorption of energy, until such time as the energy absorber elongates to the length of the woven webbing material, whereupon elongation stops, and further loading is borne by the woven webbing material.

This energy absorber is known to be relatively inexpensive to manufacture, and to provide satisfactory energy absorption, but, by virtue of its nature, is useful only for a single use, which is disadvantageous inter alia from the standpoint of economy.

Another class of energy absorber is exemplified by U.S. Pat. No. 5,197,573 (De La Fuente et al.), issued Mar. 30, 1993.

This energy absorber, which is of all metal construction, and which dissipates kinetic energy in a fall by rolling balls which are forced by a tapered surface on an expandable sleeve to frictionally load a force rod, is suitable for repetitive use, and as such, overcomes some of the drawbacks of the class exemplified by the O'Rourke patent, but is of relatively complex and expensive construction.

### SUMMARY OF THE INVENTION

It is an object of the present invention to provide an energy absorber for use in a fall protection system which is suitable for repetitive use and which is of relatively simple and inexpensive construction as compared to devices of similar functionality of the prior art.

This object, among others, is attained by the present invention, an energy absorber for use in a fall protection system.

As one aspect of the invention, the energy absorber comprises a housing, a plunger assembly and a quantity of resilient compressible material.

The housing has a tubular body portion and an end wall portion.

The tubular body portion has a tubular first end portion and a tubular second end portion and defines a longitudinal axis extending therebetween.

The end wall portion is secured to the first end portion to substantially occlude same and has defined therethrough an aperture disposed about said longitudinal axis.

The plunger assembly, which includes a plunger head disposed within said body portion and a plunger rod rigidly extending from said plunger head, through the aperture in the end wall portion, to a terminal end, is disposed at a rest position, whereat the plunger head is relatively distal to the end wall portion, and is mounted to said housing for longitudinal movement between the rest position and an extended position, whereat the plunger head is relatively proximal to the end wall portion.

The quantity of resilient compressible material is disposed within said body portion between the end wall portion and the plunger head for compression by the plunger head upon movement of the plunger assembly from the rest position to the extended position thereof, and is adapted to absorb energy in the course of such compression in a manner such that, if the terminal end of the plunger rod and the second end portion of the body portion are drawn apart by the load of an object of a predetermined mass falling a predetermined distance, the maximum arrest force exerted on the object does not exceed a predetermined level.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinafter.

### BRIEF DESCRIPTION OF THE DRAWINGS

In the accompanying drawings, wherein similar reference numerals denote similar parts, and which are for the purpose of illustration and description only, and are not intended as a definition of the limits of the invention:

FIG. 1 is a perspective view of an energy absorber according to a preferred embodiment of the present invention;

FIG. 2 is a front elevational view of the energy absorber of FIG. 1;

FIG. 3 is a side elevational view of the energy absorber of FIG. 1;

FIG. 4 is a top plan view of the energy absorber of FIG. 1;

FIG. 5 is a partial cross-sectional view of the energy absorber of FIG. 1 along line 5-5 of FIG. 4 showing a plunger assembly of the energy absorber at its rest position within a housing of the energy absorber;

FIG. 6 is a view similar to FIG. 5, with the plunger assembly partially withdrawn from the housing;

FIG. 7 is a view similar to FIG. 6, with the plunger assembly further withdrawn from the housing;

FIG. 8 is a view similar to FIG. 7, with the plunger assembly at an extended position thereof;

FIG. 9 is a front elevational view of an energy absorber according to an alternate embodiment of the invention;

FIG. 10 is a side elevational view of the energy absorber of FIG. 9;

FIG. 11 is a view, similar to FIG. 5, of the energy absorber of FIG. 9;

FIG. 12 is a view similar to FIG. 11, with the plunger assembly of the energy absorber partially withdrawn from its housing;

FIG. 13 is a view similar to FIG. 8, of the energy absorber of FIG. 9;

FIG. 14 is a view similar to FIG. 13, with the plunger assembly retracted slightly into the housing and engaged by gripping arms of the energy absorber;

FIG. 15 is a view similar to FIG. 14;

FIG. 16 is a partially exploded view of the structure of FIG. 15;

FIG. 17 is a view similar to FIG. 16, with the gripping arms pivoted to respective release positions;

FIG. 18 is a view similar to FIG. 11;

FIG. 19A is an enlarged detail view of the encircled area 19A in FIG. 16; and

FIG. 19B is an enlarged detail view of the encircled area 19B in FIG. 17.

### DETAILED DESCRIPTION OF A PREFERRED EMBODIMENT

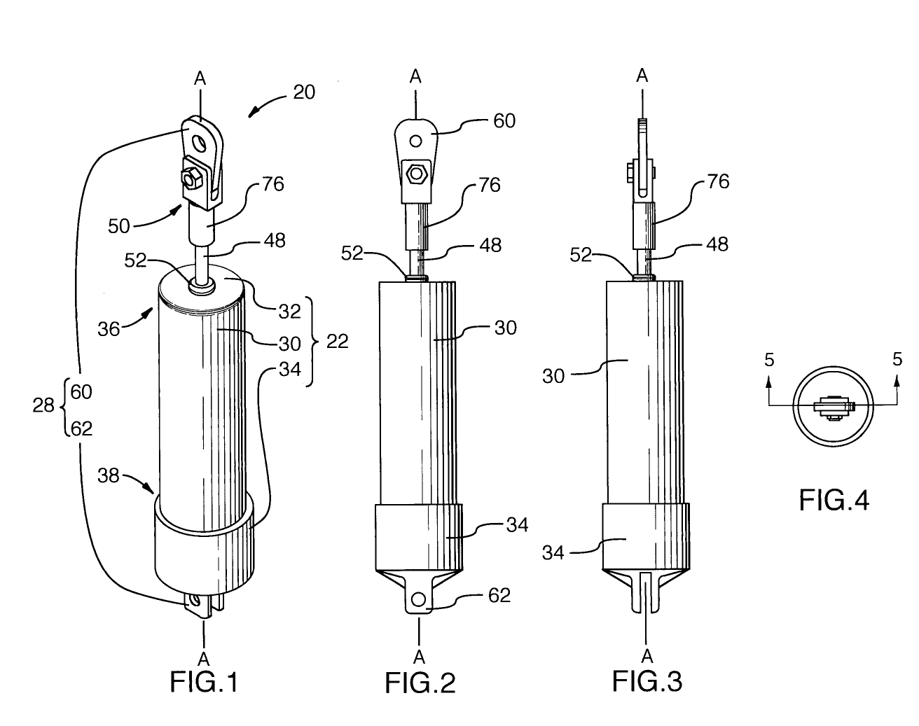

Referring now generally to FIG. 1 and FIG. 5 of the drawings, an energy absorber, for use in a fall protection system and according to a preferred embodiment of the present invention is shown and designated with general reference numeral 20.

The energy absorber 20 includes a housing 22, a plunger assembly 24, a quantity of compressible material 26 and connection means, designated with general reference numeral 28, for operatively interposing the energy absorber 20 between a lifeline and an anchorage, a safety harness or a safety belt (not shown).

The housing 22 has a tubular body portion 30, an end wall portion 32 and a cap 34.

The tubular body portion 30 is cylindrical, is constructed of steel, has a tubular first end portion 36 and a tubular second end portion 38 and defines a longitudinal axis A-A extending therebetween.

The end wall portion 32 is also constructed from steel, is secured to the first end portion 36 by welding to substantially occlude same, and has defined therethrough an aperture 40 disposed about said longitudinal axis A-A, as best seen in FIG. 5.

The cap 34 is similarly constructed of steel, and is threaded on the second end portion 38 via mating threads 42,44 provided, respectively, interiorly on the cap 34 and exteriorly on the second end portion 38.

The plunger assembly 24 includes a plunger head 46 and a plunger rod 48 rigidly extending from the plunger head 46 to a terminal end 50, both of steel. In the preferred embodiment illustrated, the plunger rod 48 is threaded on its exterior, and is threadingly secured to the plunger head 46, and then welded.

The plunger head 46 is mounted in the manner of a piston within said body portion 30, and the plunger rod 48 extends from said plunger head 46, through the aperture 40 in the end wall portion 32 in the manner of a piston rod, to provide for longitudinal movement of the plunger assembly 24 between a rest position, shown in FIG. 5, whereat the plunger head 46 is relatively distal to the end wall portion 32, and an extended position shown in FIG. 8, whereat the plunger head 46 is relatively proximal to the end wall portion 32.

A grommet 52, constructed of EPDM, is disposed in encircling relation to the plunger rod 48 and disposed, in use, in sealing relation against the aperture 40, when the plunger assembly 24 is at the rest position, as shown in FIG. 5, to arrest infiltration of moisture into the housing 22.

The quantity of resilient compressible material 26 is a compressible tubular cushion disposed in said body portion 30 between the end wall portion 32 and the plunger head 46 in spaced-relation to the body portion 30, in close-fitting relation to the end wall portion 32 and to the plunger head 46, and in surrounding relation to the plunger rod 48.

The tubular cushion 26 comprises a plurality of longitudinally-stacked tubular cushion segments 54.

Each tubular cushion segment 54 has defined thereon a plurality of annular grooves 56, longitudinally-spaced from one another and arranged coaxial to the body portion 30, and has a plurality of substantially cylindrical exterior surfaces 58, coaxial with the body portion 30 and separated from one another by the annular grooves 56.

The tubular cushion 26 is constructed from an NBR/PVC elastomer having a hardness of 65 Shore A (ASTM D-2240), tensile strength of 3700 psi (ASTM D-412); modulus 1.8 mPa (ASTM D-412); elongation 530% (ASTM D-412); specific gravity 1.13; compressive deflection of 20% and compression of 8.7% (70EC).

The connection means 28 comprises a first lug 60 and a second lug 62; the first lug 60 is bolted to a jaw socket 76, which is threaded to the terminal end 50 of the plunger rod 48, and the second lug 62 is cast integrally with the cap 34.

In use, the first lug 60 and the second lug 62 are conventionally secured to a harness and a lanyard, by respective carabiners or quick links (not shown), so as to operatively interpose the energy absorber 20 between the harness of a worker and a lifeline, or alternatively, the first lug 60 is secured to a lifeline, and the second lug is secured to an anchorage therefor (not shown), so as to operatively interpose the energy absorber between the lifeline and the anchorage. This provides, in a fall situation, for the terminal end 50 of plunger rod 48 and the second end portion 38 of the body portion 30 to be drawn apart by the load of the falling worker, for consequent compression of the tubular cushion 26, and for storage of the kinetic energy removed from the falling worker in the tubular cushion 26, thereby reducing the maximum arrest force exerted on the falling worker, and decreasing loads on the anchorage. Within the range of forces to which the energy absorber may be reasonably expected to be exposed in use, the compressible material has substantially elastic deformation, and thus, is suitable for repetitive use.

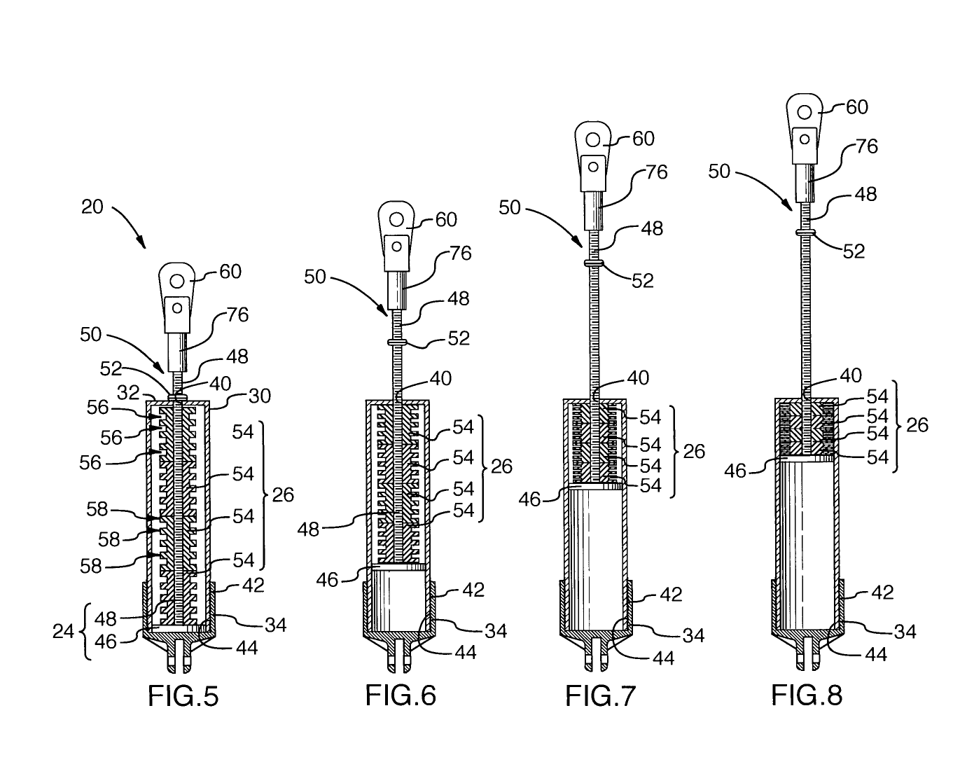

The sequence of FIG. 5 through FIG. 8 illustrates the terminal end 50 of the plunger rod 48 and the second end portion 38 of the body portion 30 being drawn apart (from the rest position of the plunger assembly 24 to the extended position of the plunger assembly 24), as would occur in use.

The various components of the energy absorber described above may be tailored (choice of materials, size, etc.) by persons of ordinary skill in the art to meet different energy absorption needs, using mechanical principles well-known to such persons, which are accordingly not set out in detail herein.

### EXPERIMENTAL EXAMPLES

In one experiment, a number of energy absorbers according to the preferred embodiment were constructed as follows:

| | | |
|---|---|---|
| plunger rod: | ½ | inch OD |
| plunger head: | 3 | inch OD |
| body portion: | 3 | inch ID |
| tubular cushion segments used: | 4 | |
| tubular cushion segment length: | 3 | inch |
| cylindrical exterior surfaces: | 2 | inch OD |
| annular grooves radial depth: | 3/6 | inch |
| annular grooves longitudinal width: | ⅓ | inch |
| annular grooves longitudinal spacing: | ⅓ | inch |

Energy absorbers so constructed were affixed to each of two anchorages, horizontally spaced-apart approximately 60 feet from one another, and a conventional lifeline was operatively affixed to each energy absorber. As well, a further energy absorber so constructed was affixed to a 100 kg weight, and in turn, affixed to the lifeline by a conventional 1.8 metre lanyard.

The weight was allowed to fall freely a distance of 1.8 metres, and forces were measured, whereupon it was observed that anchorage forces were in the range of 8-12 KN and that the maximum arrest force exerted on the weight was in the range 3.5 KN, both of which figures being well within the prescribed standards in North America.

In another test, a single energy absorber, constructed as above, was affixed between a 100 kg weight and an anchored 1.8 metre lanyard, the weight was permitted to drop 1.8 metres, and forces were measured. Again, measurements showed that the maximum arrest force exerted on the weight was in the range 3.5 KN which is beneath injury levels for average healthy adults, and in any event, is within the applicable North American safety standard of 4 KN. (In both cases, undesirable levels of rebound were not observed.)

Of course, it is also possible to satisfy differing energy absorption needs by modifying the manner in which the energy absorber is used (as opposed to modifying the structure of the energy absorber itself).

As one example, a pair of energy absorbers may be utilized in parallel, to meet the energy absorption needs of persons whose mass exceeds 100 kg.

As another example, a flexible strength component (not shown), of a length greater than the distance between the first lug and the second lug when the plunger assembly is at its extended position, and having a selected static breaking strength which is greater than the maximum tension shock load encountered in the projected use of the fall protection system, may be coupled in use between the first lug and the second lug, to provide for redundancy, in the event of a mechanical failure in the energy absorber.

It should also be appreciated that various modifications and alterations may be used in the design and manufacture of the energy absorber according to the present invention, for reasons unrelated to energy absorption needs.

For example, whereas in the preferred embodiment illustrated, the body portion is cylindrical, it will be evident that other shapes could be readily employed with equal utility.

Similarly, whereas in the preferred embodiment illustrated, the annular grooves are substantially square in radial cross-section, this need not be the case, and indeed, the grooves may be omitted entirely.

Additionally, whereas in the preferred embodiment, the cap is provided, and is threaded on the exterior of the second end portion of the body portion to occlude same and constrain the plunger assembly against longitudinal movement beyond the rest position thereof, it will be evident that the cap could readily be welded in place, or omitted altogether.

Further, whereas in the preferred embodiment, the end wall portion and the body portion are welded to one another, other connections could be employed (such as screw threading), or the end wall portion and the body portion could be formed integrally, for example, by casting.

Likewise, whereas the second lug and the cap of the preferred embodiment are constructed integrally, same could, for example, be stamped separately, and welded to one another.

As well, whereas the grommet of the preferred embodiment is constructed of EPDM, it will be evident that other materials could be employed, and indeed, the grommet could readily be omitted altogether if suitable water resistant materials were employed for the remaining components. Yet further, whereas the preferred embodiment employs an NBR/PVC polymer having a hardness of 65 Shore A for the tubular cushion, other polymers may be employed with similar utility. Polymers selected from NBR/PVC, NBR and neoprene, of hardness ranging between 40 and 60 durometer Shore A, have proven useful in this application.

In addition to the foregoing, whereas in the preferred embodiment illustrated, the tubular cushion has physical properties which enable same to absorb sufficient kinetic energy to avoid injury in persons using the same, while at the same time, unexpectedly, avoiding injuriously energetic rebound, it should be understood that it is possible to employ tubular cushions constructed out of compressible material having different physical characteristics, in which case arresting means for arresting movement of the plunger assembly towards the rest position thereof may be employed to avoid potentially injurious rebound.

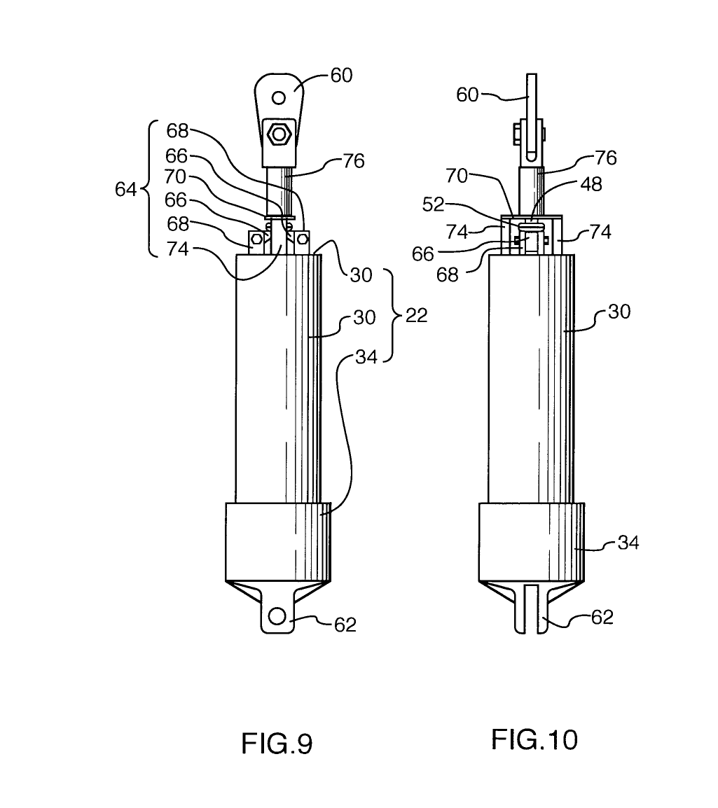

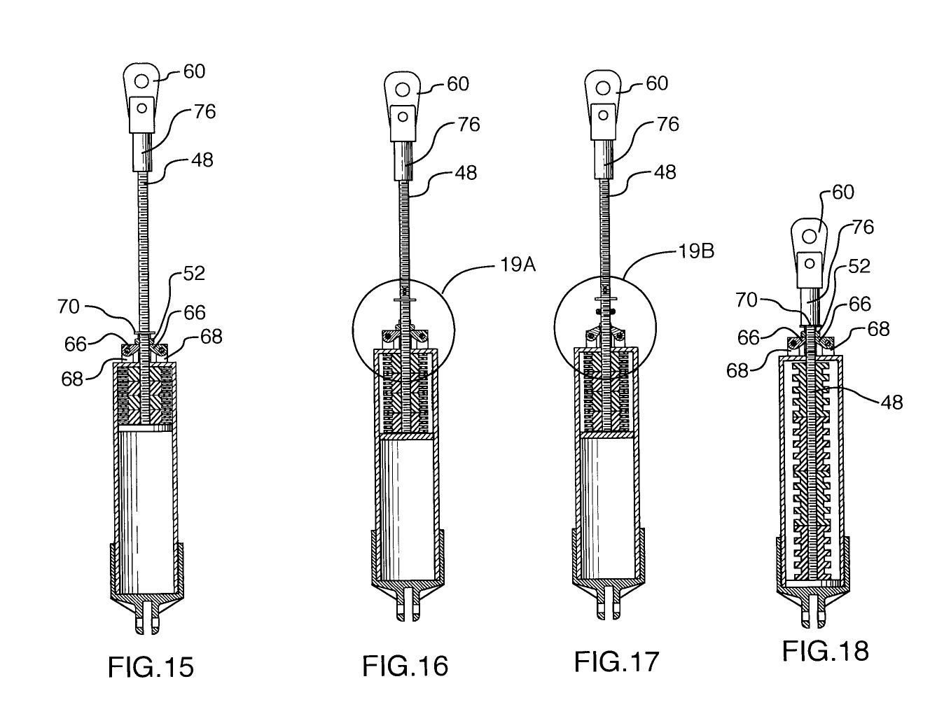

An alternative embodiment of the present invention, wherein such arresting means are provided, and designated with reference numeral 64, is illustrated in FIGS. 9-19B.

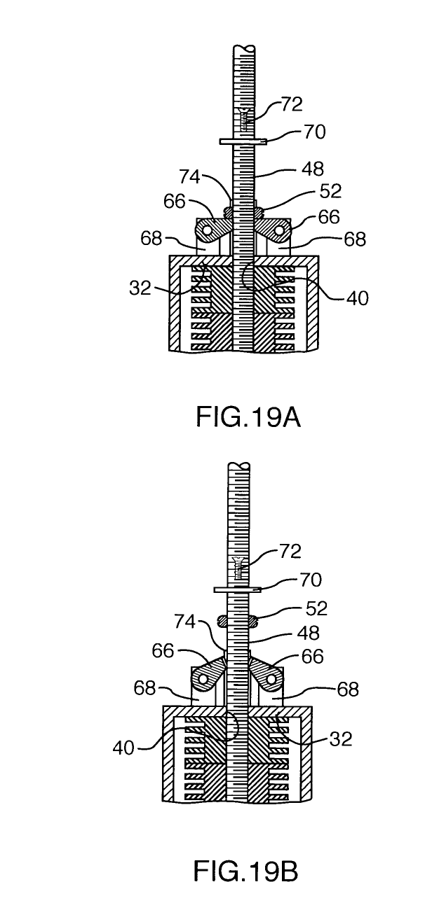

As best indicated in FIG. 9 and FIG. 10, the arresting means 64 comprises a pair of gripping arms 66 disposed on opposite radial sides of the plunger rod 48, exteriorly of the housing 22. Each gripping arm 66 is operatively pivotally mounted to the housing 22 for pivotal movement between a gripping position, whereat it bears in frictionally-gripping relation against the plunger rod 48, as best illustrated in FIG. 19A, and a release position, whereat it is disposed apart from the plunger rod 48 to permit movement thereof, as best illustrated in FIG. 19B.

Such mounting is provided in the alternate embodiment illustrated via a pair of arm mounts 68 secured to the end wall portion 32 on opposite radial sides of the aperture 40, each having a respective one of the gripping arms 66 pivotally mounted thereto for said pivotal movement, as best indicated in the sequence of FIGS. 19A, 19B.

The arresting means 64 further comprises a pair of plate mounts 74 and a limit plate 70. The plate mounts 74 are welded to the end wall portion 32 on opposite radial sides of the plunger rod 48. The limit plate 70 is releasably secured, by screws 72 (best illustrated in FIGS. 19A, 19B) to the pair of plate mounts 74, in overlying relation to gripping arms 66, as best illustrated in FIGS. 9,10, so as to constrain movement of the gripping arms 66 beyond their respective release positions.

In normal operation, the energy absorber of the alternate embodiment is interposed into a fall protection system in the conventional manner previously discussed, with care being taken to ensure that, in a fall situation, the first lug 60 is disposed above the second lug 62.

In this condition, gravity biases gripping arms 66 for movement towards their respective gripping positions.

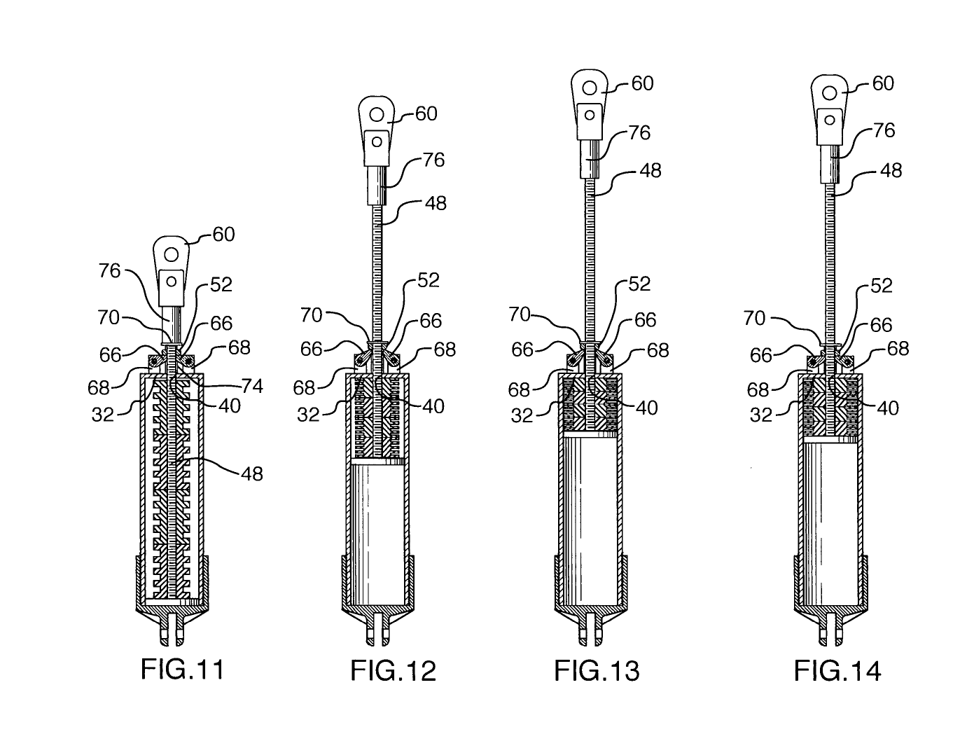

In fall conditions, the plunger assembly 24 will be drawn from its rest position towards its extended position, by the load of the falling object, as indicated by the sequence of FIGS. 11-13. As this occurs, the gripping arms 66 will be pivoted, by frictional engagement with the plunger rod 48, towards their respective release positions, until same impinge upon grommet 52, which is retained as against movement by limit plate 70.

At the extended position of the plunger assembly 24, movement of the plunger rod 48 momentarily ceases, and then reverses, during which process, gripping arms 66 are urged by bias provided by grommet 52, by gravity, and by frictional engagement with the reversing plunger rod 48, into their gripping positions, as shown in FIG. 14, whereat further retraction of plunger assembly 24 is arrested.

For reuse, the screws 72 securing limit plate 70 in position may be removed. Thereafter, the limit plate 70 can be removed, the gripping arms 66 can be manipulated to their release positions, and the plunger assembly 24 may be reinstated at its rest position, whereupon the energy absorber may be reassembled for further use.

Although only two embodiments of the present invention are herein described with particularity, from the foregoing it will be evident that other embodiments falling within the scope of the invention are possible.

For example, whereas in the alternate embodiment illustrate, gravity biases the gripping arms for movement towards their respective gripping positions, it is possible to modify the size and physical characteristics of the grommet to so bias the gripping arms and obviate the need to ensure that the energy absorber is deployed in an upright manner in use.

Accordingly, it should be understoodthat the scope of the exclusive property and privilege sought is limited only by the accompanying claims, purposively construed.

I claim:

1. An energy absorber for use in a fall protection system, said energy absorber comprising:
a housing having
a tubular body portion having a tubular first end portion and a tubular second end portion and defining a longitudinal axis extending therebetween;
an end wall portion secured to the first end portion to substantially occlude same and having defined therethrough an aperture disposed about said longitudinal axis;
a plunger assembly including a plunger head disposed within said body portion and a plunger rod rigidly extending from said plunger head, through the aperture in the end wall portion, to a terminal end, the plunger assembly being disposed at a rest position, whereat the plunger head is relatively distal to the end wall portion, and being mounted to said housing for longitudinal movement between the rest position and an extended position, whereat the plunger head is relatively proximal to the end wall portion; and
a quantity of resilient compressible material disposed within said body portion between the end wall portion and the plunger head for compression by the plunger head upon movement of the plunger assembly from the rest position to the extended position thereof, and is adapted to absorb energy in the course of such compression in a manner such that, if the terminal end of the plunger rod and the second end portion of the body portion are drawn apart by the load of an object of a predetermined mass falling a predetermined distance, the maximum arrest force exerted on the object does not exceed a predetermined level.

2. An energy absorber according to claim 1, wherein the plunger head is mounted in the manner of a piston within the body portion and the plunger rod extends through the aperture in the manner of a piston rod to provide for said longitudinal movement of the plunger assembly.

3. An energy absorber according to claim 1, wherein the quantity of resilient compressible material is a compressible tubular cushion disposed in the housing in spaced-relation to the main body portion, in close-fitting relation to the end wall portion and to the plunger head, and in surrounding relation to the plunger rod.

4. An energy absorber according to claim 3, wherein the tubular cushion comprises a plurality of longitudinally-stacked tubular cushion segments.

5. An energy absorber according to claim 4, wherein each tubular cushion segment has defined thereon a plurality of annular grooves, longitudinally-spaced from one another and arranged coaxial to the body portion.

6. An energy absorber according to claim 5, wherein each tubular cushion segment has a plurality of substantially cylindrical exterior surfaces, coaxial with the body portion and separated from one another by the annular grooves.

7. An energy absorber according to claim 6, wherein the body portion is a round tube.

8. An energy absorber according to claim 7, wherein the tubular cushion is constructed from an elastomer having a hardness of 65 Shore A (ASTM D-2240), tensile strength of 3700 psi (ASTM D-412); modulus 1.8 mPa (ASTM D-412); elongation 530% (ASTM D-412); s.g. 1.13; compressive deflection of 20% and compression of 8.7% (70 EC).

9. An energy absorber according to claim 8, wherein the elastomer is a blend of nitrile rubber and polyvinyl chloride.

10. An energy absorber according to claim 9, wherein the annular grooves are substantially square in radial cross-section

11. An energy absorber according to claim 1, further comprising a cap threaded on the exterior of the second end portion of the body portion to occlude same and constrain the plunger assembly against longitudinal movement beyond the rest position.

12. An energy absorber according to claim 1, further comprising arresting means for arresting movement of the plunger assembly towards the rest position thereof.

13. An energy absorber according to claim 12, wherein the arresting means comprises a pair of gripping arms disposed on opposite radial sides of the plunger rod, exteriorly of the housing, each gripping arm being operatively pivotally mounted to the housing for pivotal movement between a gripping position, whereat it bears in frictionally-gripping relation against the plunger rod, and a release position, whereat it is disposed apart from the plunger rod.

14. An energy absorber according to claim 13, further comprising a pair of arm mounts secured to the end wall portion, on opposite radial sides of the aperture, each having a respective one of the gripping arms pivotally mounted thereto for said pivotal movement.

15. An energy absorber according to claim 14, further comprising a limit plate operatively mounted to the housing in overlying relation to the gripping arms to constrain movement of the gripping arms beyond their respective release positions.

16. An energy absorber according to claim 15, wherein the limit plate is operatively releasably mounted to the housing.

17. An energy absorber according to claim 1, further comprising a grommet disposed in encircling relation to the plunger rod and disposed, in use, in sealing relation against the aperture to arrest infiltration of moisture when the plunger assembly is at the rest position.

18. An energy absorber according to claim 1, wherein the predetermined mass is 100 kilograms, the predetermined distance is 1.8 meters and the predetermined level is 4 kN and wherein, in use, the fall protection system does not expose the falling object to undesirable levels of rebound.

19. An energy absorber according to claim 1, further comprising connection means for operatively interposing the energy absorber between a lifeline and a safety harness or belt.

20. An energy absorber according to claim 19, wherein the connection means comprises a first lug bolted to the terminal end of the plunger rod and a second lug formed integrally with the cap.
